(19) United States
(12) Patent Application Publication
(10) Pub. No.: US 2015/0226916 A1
(43) Pub. Date: Aug. 13, 2015

(54) MULTI MODE OPTICAL FIBER

(71) Applicant: SUMITOMO ELECTRIC INDUSTRIES, LTD., Osaka (JP)

(72) Inventors: Itaru SAKABE, Yokohama-shi (JP); Sotaro IDA, Yokohama-shi (JP); Tomoyuki HATTORI, Yokohama-shi (JP)

(73) Assignee: SUMITOMO ELECTRIC INDUSTRIES, LTD., Osaka (JP)

(21) Appl. No.: 14/175,252

(22) Filed: Feb. 7, 2014

(51) Int. Cl. G02B 6/028

(52) U.S. Cl. CPC G02B 6/0288

(57) ABSTRACT

A multi mode optical fiber includes a core having a refractive index distribution of a curved form, a central part in a radial direction of which protrudes, a cladding provided in the periphery of the core and having a constant refractive index lower than a refractive index of the core and a trench layer provided between the core and the cladding and having a constant refractive index lower than that of the cladding. A width dimension of the trench layer in the radial direction is set to 2 μm or smaller and a ratio of an absolute value of Δ trench that is a refractive index difference between the cladding and the trench layer to an absolute value of Δ core that is a maximum refractive index difference between the cladding and the core is set to 0.5 or larger.

### BACKGROUND

1. Technical Field

The present invention relates to a multi mode optical fiber and a manufacturing method of the multi mode optical fiber.

2. Related Art

A multi mode optical fiber which has a core, an inner cladding and a trench with a low refractive index has been known. In the multi mode optical fiber, the core is arranged in an inner optical cladding and has a refractive index profile of α-th power distribution. The inner cladding is arranged between the core and an outer optical cladding and has a second radius and a first refractive index difference relative to the outer optical cladding. Further, the trench with the low refractive index is arranged between the inner cladding and the outer optical cladding and has a first width and a second refractive index difference relative to the outer optical cladding. In the multi mode optical fiber, a refractive index difference between the core and the inner optical cladding is set to zero in a first radius of the core (see patent literature 1).

### PRIOR ART LITERATURE

### Patent Literature

[Patent Literature 1] U.S. Pat. No. 8,520,993

Since, in the multi mode optical fiber (MMF), fibers can be easily connected together and the multi mode optical fiber is strong to a bending, the multi mode optical fiber is used for, for instance, a connection of a LAN (Local Area Network) or a cable to be mounted on a vehicle.

An optical fiber is requested to have a small increase in transmission loss to a bending of, for instance, a bend radius of 7.5 mm, namely, to be excellent in its bending property prescribed in the International Standard. However, when the optical fiber is actually used in a data center or an ordinary home, the optical fiber may be nipped by a door, caught by edges of a rack or equipments and materials, or entangled during a wiring operation. Thus, the optical fiber may be sometimes bent up to the bend radius of about 2 mm. Therefore, the optical fiber is requested to be wired without considering the bend radius like a general-purpose electric wire.

On the other hand, in a light receiving element such as a photodiode which receives lights outputted from an output end of the optical fiber, a range which receives the lights is limited. Accordingly, in the optical fiber, a numerical aperture needs to be made as small as possible.

### SUMMARY

An object of the present invention is to provide a multi mode optical fiber which is excellent in its bending property and a manufacturing method of the multi mode optical fiber.

One aspect of a multi mode optical fiber of the present invention, which can solve the problems, comprises:

a core having a refractive index distribution of a curved form, a central part in a radial direction of which protrudes;

a cladding provided in the periphery of the core and having a constant refractive index lower than a refractive index of the core; and

a trench layer provided between the core and the cladding and having a constant refractive index lower than that of the cladding,

wherein a width dimension of the trench layer in the radial direction is set to 2 μm or smaller and a ratio of an absolute value of Δ trench that is a refractive index difference between the cladding and the trench layer to an absolute value of Δ core that is a maximum refractive index difference between the cladding and the core is set to 0.5 or larger.

Further, another aspect of a multi mode optical fiber of the present invention, comprises:

a core having a refractive index distribution of a curved form, a central part in a radial direction of which protrudes;

a cladding provided in the periphery of the core and having a constant refractive index lower than a refractive index of the core; and

a trench layer provided so as to come into contact with an outer periphery of the core between the core and the cladding and having a constant refractive index lower than that of the cladding,

wherein a width dimension of the trench layer in the radial direction is set to 3 μm or smaller and a ratio of an absolute value of Δ trench that is a refractive index difference between the cladding and the trench layer to an absolute value of Δ core that is a maximum refractive index difference between the cladding and the core is set to 0.5 or larger.

Furthermore, the other aspect of a multi mode optical fiber of the present invention, comprises:

a core having a refractive index distribution of a curved form, a central part in a radial direction of which protrudes;

a cladding provided in the periphery of the core and having a constant refractive index lower than a refractive index of the core; and

a trench layer provided so as to come into contact with an outer periphery of the core between the core and the cladding and having a constant refractive index lower than that of the cladding,

wherein a width dimension of the trench layer in the radial direction is set to 2 μm or larger and 3 μm or smaller and a ratio of an absolute value of Δ trench that is a refractive index difference between the cladding and the trench layer to an absolute value of Δ core that is a maximum refractive index difference between the cladding and the core is set to 0.55 or larger.

Further, the other aspect of the multi mode optical fiber of the present invention, comprises:

a core having a refractive index distribution of a curved form, a central part in a radial direction of which protrudes;

a cladding provided in the periphery of the core and having a constant refractive index lower than a refractive index of the core; and

a trench layer provided so as to come into contact with an outer periphery of the core between the core and the cladding and having a constant refractive index lower than that of the cladding,

wherein a width dimension of the trench layer in the radial direction is set to 3 μm or larger and 6 μm or smaller and a ratio of an absolute value of Δ trench that is a refractive index difference between the cladding and the trench layer to an absolute value of Δ core that is a maximum refractive index difference between the cladding and the core is set to 0.9 or larger.

Further, one aspect of a manufacturing method of the multi mode optical fiber of the present invention, includes a core having a refractive index distribution of a curved form, a central part in a radial direction of which protrudes, a cladding provided in the periphery of the core and having a constant refractive index lower than a refractive index of the core, and a trench layer provided between the core and the cladding and having a constant refractive index lower than that of the cladding. The manufacturing method of the multi mode optical fiber includes an optical fiber preform manufacturing process which manufactures an optical fiber preform including a core forming process which forms a part for the core, a trench layer forming process which forms a part for the trench layer, a cladding forming process which forms a part for the cladding, and a drawing process which manufactures an optical fiber having the trench layer and the cladding formed in the periphery of the core by heating, melting and drawing downward a lower end of the optical fiber preform. Thus, by the processes respectively, the optical fiber is manufactured in which a width dimension of the trench layer in the radial direction is set to 2 μm or smaller and a ratio of an absolute value of Δ trench that is a refractive index difference between the cladding and the trench layer to an absolute value of Δ core that is a maximum refractive index difference between the cladding and the core is set to 0.5 or larger.

Further, another aspect of a manufacturing method of the multi mode optical fiber of the present invention, includes a core having a refractive index distribution of a curved form, a central part in a radial direction of which protrudes, a cladding provided in the periphery of the core and having a constant refractive index lower than a refractive index of the core and a trench layer provided so as to come into contact with an outer periphery of the core between the core and the cladding and having a constant refractive index lower than that of the cladding. The manufacturing method of the multi mode optical fiber includes including an optical fiber preform manufacturing process which manufactures an optical fiber preform a core forming process which forms a part for the core, a trench layer forming process which forms a part for the trench layer, a cladding forming process which forms a part for the cladding, and a drawing process which manufactures an optical fiber having the trench layer and the cladding formed in the periphery of the core by heating, melting and drawing downward a lower end of the optical fiber preform. Thus, by the processes respectively, the optical fiber is manufactured in which a width dimension of the trench layer in the radial direction is set to 3 μm or smaller and a ratio of an absolute value of Δ trench that is a refractive index difference between the cladding and the trench layer to an absolute value of Δ core that is a maximum refractive index difference between the cladding and the core is set to 0.5 or larger.

Further, the other aspect of a manufacturing method of the multi mode optical fiber of the present invention includes a core having a refractive index distribution of a curved form, a central part in a radial direction of which protrudes, a cladding provided in the periphery of the core and having a constant refractive index lower than a refractive index of the core and a trench layer provided so as to come into contact with an outer periphery of the core between the core and the cladding and having a constant refractive index lower than that of the cladding. The manufacturing method of the multi mode optical fiber includes including an optical fiber preform manufacturing process which manufactures an optical fiber preform a core forming process which forms a part for the core, a trench layer forming process which forms a part for the trench layer, a cladding forming process which forms a part for the cladding, and a drawing process which manufactures an optical fiber having the trench layer and the cladding formed in the periphery of the core by heating, melting and drawing downward a lower end of the optical fiber preform. Thus, by the processes respectively, the optical fiber is manufactured in which a width dimension of the trench layer in the radial direction is set to 2 μm or larger and 3 μm or smaller and a ratio of an absolute value of Δ trench that is a refractive index difference between the cladding and the trench layer to an absolute value of Δ core that is a maximum refractive index difference between the cladding and the core is set to 0.55 or larger.

Further, the other aspect of a manufacturing method of the multi mode optical fiber of the present invention includes a core having a refractive index distribution of a curved form, a central part in a radial direction of which protrudes, a cladding provided in the periphery of the core and having a constant refractive index lower than a refractive index of the core and a trench layer provided so as to come into contact with an outer periphery of the core between the core and the cladding and having a constant refractive index lower than that of the cladding. The manufacturing method of the multi mode optical fiber includes an optical fiber preform manufacturing process which manufactures an optical fiber preform including a core forming process which forms a part for the core, a trench layer forming process which forms a part for the trench layer, a cladding forming process which forms a part for the cladding, and a drawing process which manufactures an optical fiber having the trench layer and the cladding formed in the periphery of the core by heating, melting and drawing downward a lower end of the optical fiber preform. Thus, by the processes respectively, the optical fiber is manufactured in which a width dimension of the trench layer in the radial direction is set to 3 μm or larger and 6 μm or smaller and a ratio of an absolute value of Δ trench that is a refractive index difference between the cladding and the trench layer to an absolute value of Δ core that is a maximum refractive index difference between the cladding and the core is set to 0.9 or larger.

According to the present invention, it is possible to provide a multi mode optical fiber the numerical aperture of which is made as small as possible and which is excellent in its bending property and a manufacturing method of the multi mode optical fiber.

### BRIEF DESCRIPTION OF THE DRAWINGS

FIG. 1 is a schematic sectional view for explaining a multi mode optical fiber according to a first exemplary embodiment of the present invention and a schematic view of a refractive index distribution thereof.

FIG. 2 is a graph showing a relation between a ratio of Δ trench to A core and a width dimension of a trench layer in the multi mode optical fiber according to the first exemplary embodiment.

FIG. 3 is a graph showing a relation between a ratio of Δ trench to A core and a width dimension of a trench layer in a multi mode optical fiber according to a second exemplary embodiment.

FIG. 4 is a graph showing a relation between a ratio of Δ trench to A core and a width dimension of a trench layer in a multi mode optical fiber according to a third exemplary embodiment.

FIG. 5 is a graph showing a relation between a ratio of Δ trench to A core and a width dimension of a trench layer in a multi mode optical fiber according to a fourth exemplary embodiment.

FIG. 6 is a schematic sectional view for explaining a multi mode optical fiber of a modified example of the first exemplary embodiment and a schematic view of a refractive index distribution thereof.

FIG. 7 is a schematic diagram of an apparatus used in a process that glass particles are deposited in a manufacturing method of the multi mode optical fiber of the present invention.

FIG. 8 is a schematic diagram of an apparatus used in a process that glass particles are deposited in the manufacturing method of the multi mode optical fiber of the present invention.

FIG. 9 is a graph showing relations between a ratio of Δ trench to A core and a width dimension of a trench layer in multi mode optical fibers as evaluation samples of examples.

### DETAILED DESCRIPTION

### Summary of Exemplary Embodiments of the Present Invention

Initially, a summary of exemplary embodiments of the present invention will be described below.

An exemplary embodiment of a multi mode optical fiber according to the present invention includes:

(1) a core having a refractive index distribution of a curved form, a central part in a radial direction of which protrudes,

a cladding provided in the periphery of the core and having a constant refractive index lower than a refractive index of the core and

a trench layer provided between the core and the cladding and having a constant refractive index lower than that of the cladding,

wherein a width dimension of the trench layer in the radial direction is set to 2 μm or smaller and a ratio of an absolute value of Δ trench that is a refractive index difference between the cladding and the trench layer to an absolute value of Δ core that is a maximum refractive index difference between the cladding and the core is set to 0.5 or larger.

According to the structure of (1), since the ratio of the Δ trench to the Δ core is 0.5 or larger, a good bending property can be ensured. Thus, the multi mode optical fiber can withstand a practical use in which the multi mode optical fiber is sometimes bent to a bend radius of about 2 mm, so that the multi mode optical fiber can be wired without considering the bend radius like a general-purpose electric wire. Further, since the width dimension of the trench layer in the radial direction is set to 2 μm or smaller, a numerical aperture can be made small, and lights can be effectively guided to a light receiving range of a light receiving element such as a photodiode and a connection loss to the light receiving element can be suppressed to be low.

(2) A flat part having the same refractive index as that of the cladding is preferably provided between the core and the trench layer.

According to the structure of (2), since the flat part is provided, the numerical aperture can be made small and the bending property can be more improved.

(3) The numerical aperture is preferably set to 0.24 or smaller.

According to the structure of (3), since the numerical aperture is set to 0.24 or smaller, the lights can be effectively guided to the light receiving range of the light receiving element such as the photodiode and the connection loss to the light receiving element can be suppressed to be low.

An exemplary embodiment of a multi mode optical fiber according to the present invention includes:

(4) a core having a refractive index distribution of a curved form, a central part in a radial direction of which protrudes,

a cladding provided in the periphery of the core and having a constant refractive index lower than a refractive index of the core, and

a trench layer provided so as to come into contact with an outer periphery of the core between the core and the cladding and having a constant refractive index lower than that of the cladding,

wherein a width dimension of the trench layer in the radial direction is set to 3 μm or smaller and a ratio of an absolute value of Δ trench that is a refractive index difference between the cladding and the trench layer to an absolute value of a A core that is maximum refractive index difference between the cladding and the core is set to 0.5 or larger.

According to the structure of (4), since the ratio of the Δ trench to the Δ core is 0.5 or larger, a good bending property can be ensured. Thus, the multi mode optical fiber can withstand a practical use in which the multi mode optical fiber is sometimes bent to a bend radius of about 2 mm, so that the multi mode optical fiber can be wired without considering the bend radius like a general-purpose electric wire. Further, since the width dimension of the trench layer in the radial direction is set to 3 μm or smaller, a numerical aperture can be made small, and lights can be effectively guided to a light receiving range of a light receiving element such as a photodiode and a connection loss to the light receiving element can be suppressed to be low.

(5) The ratio of the absolute value of the Δ trench to the absolute value of the Δ core is preferably set to 0.6 or larger.

According to the structure of (5), since the ratio of the Δ trench to the Δ core is set to 0.6 or larger, the bending property can be more improved.

(6) The numerical aperture is preferably set to 0.24 or smaller.

According to the structure of (6), since the numerical aperture is 0.24 or smaller, the lights can be effectively guided to the light receiving range of the light receiving element such as the photodiode and the connection loss to the light receiving element can be suppressed to be low.

An exemplary embodiment of a multi mode optical fiber according to the present invention includes:

(7) a core having a refractive index distribution of a curved form, a central part in a radial direction of which protrudes;

a cladding provided in the periphery of the core and having a constant refractive index lower than a refractive index of the core; and

a trench layer provided so as to come into contact with an outer periphery of the core between the core and the cladding and having a constant refractive index lower than that of the cladding,

wherein a width dimension of the trench layer in the radial direction is set to 2 μm or larger and 3 μm or smaller and a ratio of an absolute value of Δ trench that is a refractive index difference between the cladding and the trench layer to an absolute value of Δ core that is a maximum refractive index difference between the cladding and the core is set to 0.55 or larger.

According to the structure of (7), since the ratio of the Δ trench to the Δ core is 0.55 or larger, a good bending property can be ensured. Thus, the multi mode optical fiber can withstand a practical use in which the multi mode optical fiber is sometimes bent to a bend radius of about 2 mm, so that the multi mode optical fiber can be wired without considering the bend radius like a general-purpose electric wire. Further, since the width dimension of the trench layer in the radial direction is set to 2 μm or larger and 3 μm or smaller, a numerical aperture can be made small, and lights can be effectively guided to a light receiving range of a light receiving element such as a photodiode and a connection loss to the light receiving element can be suppressed to be low.

(8) A numerical aperture is preferably set to 0.24 or smaller.

According to the structure of (8), since the numerical aperture is 0.24 or smaller, the lights can be effectively guided to the light receiving range of the light receiving element such as the photodiode and the connection loss to the light receiving element can be suppressed to be low.

An exemplary embodiment of a multi mode optical fiber according to the present invention includes:

(9) a core having a refractive index distribution of a curved form, a central part in a radial direction of which protrudes;

a cladding provided in the periphery of the core and having a constant refractive index lower than a refractive index of the core; and

a trench layer provided so as to come into contact with an outer periphery of the core between the core and the cladding and having a constant refractive index lower than that of the cladding,

wherein a width dimension of the trench layer in the radial direction is set to 3 μm or larger and 6 μm or smaller and a ratio of an absolute value of Δ trench that is a refractive index difference between the cladding and the trench layer to an absolute value of Δ core that is a maximum refractive index difference between the cladding and the core is set to 0.9 or larger.

According to the structure of (9), since the ratio of the Δ trench to the Δ core is 0.9 or larger, a good bending property can be ensured. Thus, the multi mode optical fiber can withstand a practical use in which the multi mode optical fiber is sometimes bent to a bend radius of about 2 mm, so that the multi mode optical fiber can be wired without considering the bend radius like a general-purpose electric wire. Further, since the width dimension of the trench layer in the radial direction is set to 3 μm or larger and 6 μm or smaller, a numerical aperture can be made small, and lights can be effectively guided to a light receiving range of a light receiving element such as a photodiode and a connection loss to the light receiving element can be suppressed to be low.

(10) A numerical aperture is preferably set to 0.24 or smaller.

According to the structure of (10), since the numerical aperture is 0.24 or smaller, the lights can be effectively guided to the light receiving range of the light receiving element such as the photodiode and the connection loss to the light receiving element can be suppressed to be low.

In an exemplary embodiment of a manufacturing method of the multi mode optical fiber of the present invention,

(11) a manufacturing method of a multi mode optical fiber which includes a core having a refractive index distribution of a curved form, a central part in a radial direction of which protrudes, a cladding provided in the periphery of the core and having a constant refractive index lower than a refractive index of the core, and a trench layer provided between the core and the cladding and having a constant refractive index lower than that of the cladding, including

an optical fiber preform manufacturing process which manufactures an optical fiber preform, including a core forming process which forms a part for the core, a trench layer forming process which forms a part for the trench layer, a cladding forming process which forms a part for the cladding, and

a drawing process which manufactures an optical fiber having the trench layer and the cladding formed in the periphery of the core by heating, melting and drawing downward a lower end of the optical fiber preform,

wherein by the processes respectively, the optical fiber is manufactured in which a width dimension of the trench layer in the radial direction is set to 2 μm or smaller and a ratio of an absolute value of Δ trench that is a refractive index difference between the cladding and the trench layer to an absolute value of Δ core that is a maximum refractive index difference between the cladding and the core is set to 0.5 or larger.

According to the structure of (11), the multi mode optical fiber can be easily manufactured in which the ratio of the Δ trench to the Δ core is set to 0.5 or larger so that a good bending property may be ensured, and the width dimension of the trench layer in the radial direction is set to 2 μm or smaller so that a numerical aperture may be made small.

(12) The optical fiber preform manufacturing process preferably includes a flat part forming process which forms a part for a flat part having the same refractive index as that of the cladding between the core and the trench layer.

According to the structure of (12), the multi mode optical fiber can be easily manufactured in which the flat part is provided, the numerical aperture is made small and the bending property is more improved.

(13) The optical fiber is preferably manufactured in which a numerical aperture is set to 0.24 or smaller by the processes respectively.

According to the structure of (13), the multi mode optical fiber can be easily manufactured in which the numerical aperture is set to 0.24 or smaller, lights can be effectively guided to a light receiving range of a light receiving element such as a photodiode and a connection loss to the light receiving element can be suppressed to be low.

In an exemplary embodiment of a manufacturing method of the multi mode optical fiber of the present invention,

(14) a manufacturing method of a multi mode optical fiber which includes a core having a refractive index distribution of a curved form, a central part in a radial direction of which protrudes, a cladding provided in the periphery of the core and having a constant refractive index lower than a refractive index of the core and a trench layer provided so as to come into contact with an outer periphery of the core between the core and the cladding and having a constant refractive index lower than that of the cladding, including

an optical fiber preform manufacturing process which manufactures an optical fiber preform, including a core forming process which forms a part for the core, a trench layer forming process which forms a part for the trench layer, a cladding forming process which forms a part for the cladding, and

a drawing process which manufactures an optical fiber having the trench layer and the cladding formed in the periphery of the core by heating, melting and drawing downward a lower end of the optical fiber preform,

wherein by the processes respectively, the optical fiber is manufactured in which a width dimension of the trench layer in the radial direction is set to 3 μm or smaller and a ratio of an absolute value of Δ trench that is a refractive index difference between the cladding and the trench layer to an absolute value of Δ core that is a maximum refractive index difference between the cladding and the core is set to 0.5 or larger.

According to the structure of (14), the multi mode optical fiber can be easily manufactured in which the ratio of the Δ trench to the Δ core is set to 0.5 or larger so that a good bending property may be ensured, and the width dimension of the trench layer in the radial direction is set to 3 μm or smaller so that a numerical aperture may be made small.

(15) The optical fiber is preferably manufactured in which the ratio of the absolute value of the Δ trench to the absolute value of the Δ core is 0.6 or larger by the processes respectively.

According to the structure of (15), the multi mode optical fiber can be easily manufactured in which the ratio of the Δ trench to the Δ core is set to 0.6 or larger so that a better bending property may be ensured.

(16) The optical fiber is preferably manufactured in which a numerical aperture is set to 0.24 or smaller by the processes respectively.

According to the structure of (16), the multi mode optical fiber can be easily manufactured in which the numerical aperture is set to 0.24 or smaller, lights can be effectively guided to a light receiving range of a light receiving element such as a photodiode and a connection loss to the light receiving element can be suppressed to be low.

In an exemplary embodiment of a manufacturing method of the multi mode optical fiber of the present invention,

(17) a manufacturing method of a multi mode optical fiber which includes a core having a refractive index distribution of a curved form, a central part in a radial direction of which protrudes, a cladding provided in the periphery of the core and having a constant refractive index lower than a refractive index of the core and a trench layer provided so as to come into contact with an outer periphery of the core between the core and the cladding and having a constant refractive index lower than that of the cladding, including

an optical fiber preform manufacturing process which manufactures an optical fiber preform, including a core forming process which forms a part for the core, a trench layer forming process which forms a part for the trench layer, a cladding forming process which forms a part for the cladding, and

a drawing process which manufactures an optical fiber having the trench layer and the cladding formed in the periphery of the core by heating, melting and drawing downward a lower end of the optical fiber preform,

wherein by the processes respectively, the optical fiber is manufactured in which a width dimension of the trench layer in the radial direction is set to 2 μm or larger and 3 μm or smaller and a ratio of an absolute value of Δ trench that is a refractive index difference between the cladding and the trench layer to an absolute value of Δ core that is a maximum refractive index difference between the cladding and the core is set to 0.55 or larger.

According to the structure of (17), the multi mode optical fiber can be easily manufactured in which the ratio of the Δ trench to the Δ core is set to 0.55 or larger so that a good bending property may be ensured, and the width dimension of the trench layer in the radial direction is set to 2 μm or larger and 3 μm or smaller so that a numerical aperture may be made small.

(18) The optical fiber is preferably manufactured in which a numerical aperture is set to 0.24 or smaller by the processes respectively.

According to the structure of (18), the multi mode optical fiber can be easily manufactured in which the numerical aperture is set to 0.24 or smaller, lights can be effectively guided to a light receiving range of a light receiving element such as a photodiode and a connection loss to the light receiving element can be suppressed to be low.

In an exemplary embodiment of a manufacturing method of the multi mode optical fiber of the present invention,

(19) a manufacturing method of a multi mode optical fiber which includes a core having a refractive index distribution of a curved form, a central part in a radial direction of which protrudes, a cladding provided in the periphery of the core and having a constant refractive index lower than a refractive index of the core and a trench layer provided so as to come into contact with an outer periphery of the core between the core and the cladding and having a constant refractive index lower than that of the cladding, including

an optical fiber preform manufacturing process which manufactures an optical fiber preform, including a core forming process which forms a part for the core, a trench layer forming process which forms a part for the trench layer, a cladding forming process which forms a part for the cladding, and

a drawing process which manufactures an optical fiber having the trench layer and the cladding formed in the periphery of the core by heating, melting and drawing downward a lower end of the optical fiber preform,

wherein by the processes respectively, the optical fiber is manufactured in which a width dimension of the trench layer in the radial direction is set to 3 μm or larger and 6 μm or smaller and a ratio of an absolute value of Δ trench that is a refractive index difference between the cladding and the trench layer to an absolute value of Δ core that is a maximum refractive index difference between the cladding and the core is set to 0.9 or larger.

According to the structure of (19), the multi mode optical fiber can be easily manufactured in which the ratio of the Δ trench to the Δ core is set to 0.9 or larger so that a good bending property may be ensured, and the width dimension of the trench layer in the radial direction is set to 3 μm or larger and 6 μm or smaller so that a numerical aperture may be made small.

(20) The optical fiber is preferably manufactured in which a numerical aperture is set to 0.24 or smaller by the processes respectively.

According to the structure of (20), the multi mode optical fiber can be easily manufactured in which the numerical aperture is set to 0.24 or smaller, lights can be effectively guided to a light receiving range of a light receiving element such as a photodiode and a connection loss to the light receiving element can be suppressed to be low.

### Detail of Exemplary Embodiments of the Present Invention

Now, examples of exemplary embodiments of a multi mode optical fiber and a manufacturing method of the multi mode optical fiber according to the present invention will be described below by referring to the drawings. The present invention is not limited to these exemplified examples, and it is to be understood that all changes disclosed in claims and within a sense and a range equivalent to the claims are included.

### First Exemplary Embodiment

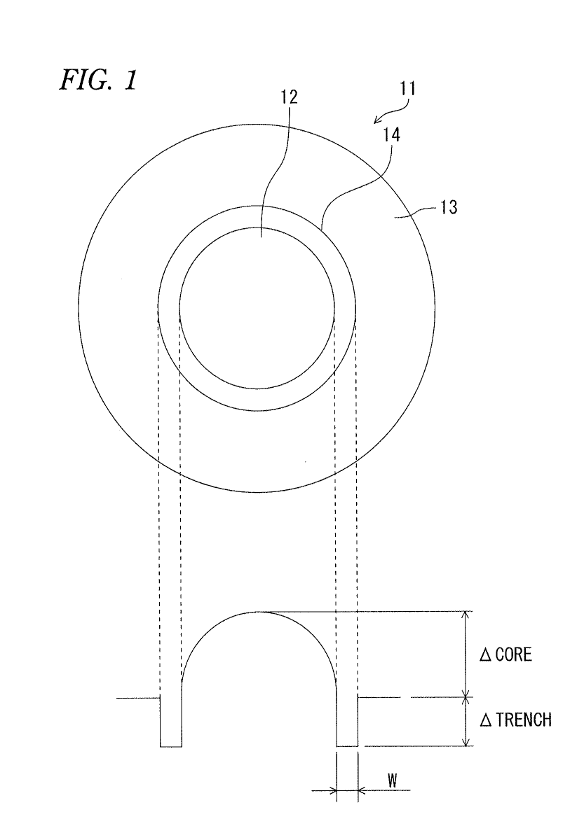

FIG. 1 is a schematic sectional view for explaining a multi mode optical fiber of the present invention and a schematic view of a refractive index distribution thereof.

As shown in FIG. 1, the multi mode optical fiber (MMF) 11 is an optical fiber which propagates optical signals having a plurality of modes and includes a core 12, a cladding 13 and a trench layer 14.

Since the multi mode optical fiber 11 is easy in its connection between fibers and strong to a bending, the multi mode optical fiber is used for, for instance, an LAN (Local Area Network) connection or a cable to be mounted on a vehicle.

The core 12 has a graded index (GI) type refractive index distribution of a curved form (for instance, a curved form defined by a curve expressed by a function of a-th power) which has the highest refractive index in a central part and has gradually a lower refractive index toward outside in a radial direction. The core 12 has a structure which suppresses the spread (mode dispersion) of the optical signal to be transmitted. In the core 12 of the present exemplary embodiment, a diameter thereof is set to 50 μm.

The cladding 13 is provided in the periphery of the core 12. The cladding 13 has a constant refractive index lower than the refractive index of the core 12. The cladding 13 has at least the constant refractive index lower than the refractive index of the center of the core 12. The cladding 13 is formed with, for instance, pure silica. In the cladding 13 of the present exemplary embodiment, an outside diameter is set to 125 μm.

The trench layer 14 is provided between the core 12 and the cladding 13. The trench layer 14 has an inside part which comes into contact with an outer periphery of the core 12 and an outside part which comes into contact with an inner periphery of the cladding 13. The trench layer 14 has a constant refractive index lower than that of the cladding 13 formed with the pure silica. When the trench layer 14 is provided, lights are prevented from leaking outside from the core 12 and transmission loss due to a bending is prevented from increasing.

In the multi mode optical fiber 11 according to the first exemplary embodiment, a width dimension W of the trench layer 14 in the radial direction is set to 2 μm or smaller. An absolute value of Δ core that is a maximum refractive index difference between the cladding 13 and the core 12 is set within a range of 0.90 to 1.09%. An absolute value of Δ trench that is a refractive index difference between the cladding 13 and the trench layer 14 is set within a range of 0.55 to 2.00%. Further, in the multi mode optical fiber 11, a ratio of the absolute value of Δ trench that is the refractive index difference between the cladding 13 and the trench layer 14 to the absolute value of Δ core that is the maximum refractive index difference between the cladding 13 and the core 12 is set to 0.5 or larger.

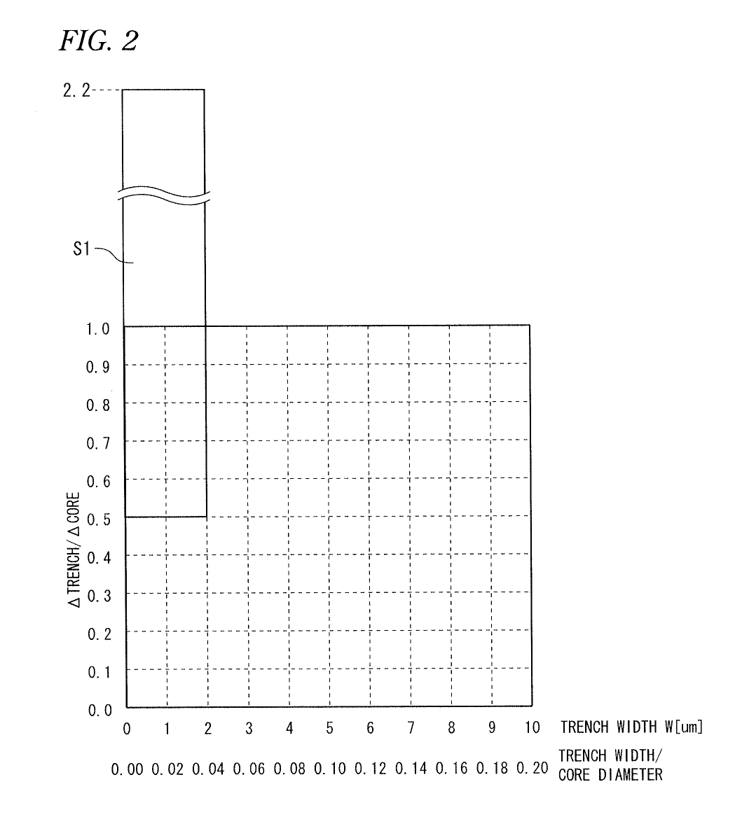

Namely, the multi mode optical fiber 11 according to the first exemplary embodiment is, as shown in FIG. 2, set to a range shown by an area S1 in the relation between the ratio of the absolute value of the Δ trench to the absolute value of the A core and the width dimension W of the trench layer 14. For instance, an upper limit value of the ratio of the absolute value of the Δ trench to the absolute value of the A core is set to 2.2 or smaller.

In the multi mode optical fiber 11 according to the first exemplary embodiment, the ratio of the absolute value of the Δ trench to the absolute value of the Δ core is set to 0.5 or larger. When the multi mode optical fiber 11 is bent, lights of a higher order mode are liable to leak. However, in the first exemplary embodiment, since the ratio of the absolute value of the Δ trench to the absolute value of the Δ core is set to 0.5 or larger, a pinch loss (an increase of a bending loss) can be suppressed to 1 dB or lower even in a bend radius of 1.75 mm. Further, since the width dimension W of the trench layer 14 in the radial direction is set to 2 μm or smaller, a numerical aperture (NA) can be made small and can be 0.24 or smaller.

In such a way, since the multi mode optical fiber 11 according to the first exemplary embodiment can ensure a good bending property, the multi mode optical fiber can withstand a practical use in which the multi mode optical fiber is sometimes bent to the bend radius of about 2 mm. Thus, the multi mode optical fiber can be wired without considering the bend radius like a general-purpose electric wire. Further, since the numerical aperture NA can be 0.24 or smaller, the lights can be guided to a light receiving range of a light receiving element such as a photodiode and a connection loss to the light receiving element can be suppressed to be low.

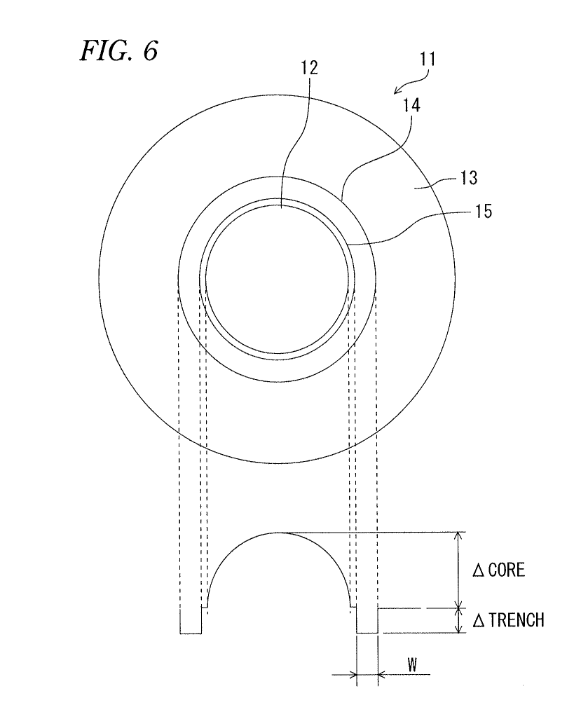

In the multi mode optical fiber 11 according to the first exemplary embodiment, even a structure of a modified example 1 which will be described below by referring to FIG. 6, namely, which includes a flat part (an inner cladding) 15 between a core 12 and a trench layer 14 can obtain the above-described effects.

Multi mode optical fibers according to other exemplary embodiments in which dimensions of parts are respectively differently set will be described below.

### Second Exemplary Embodiment

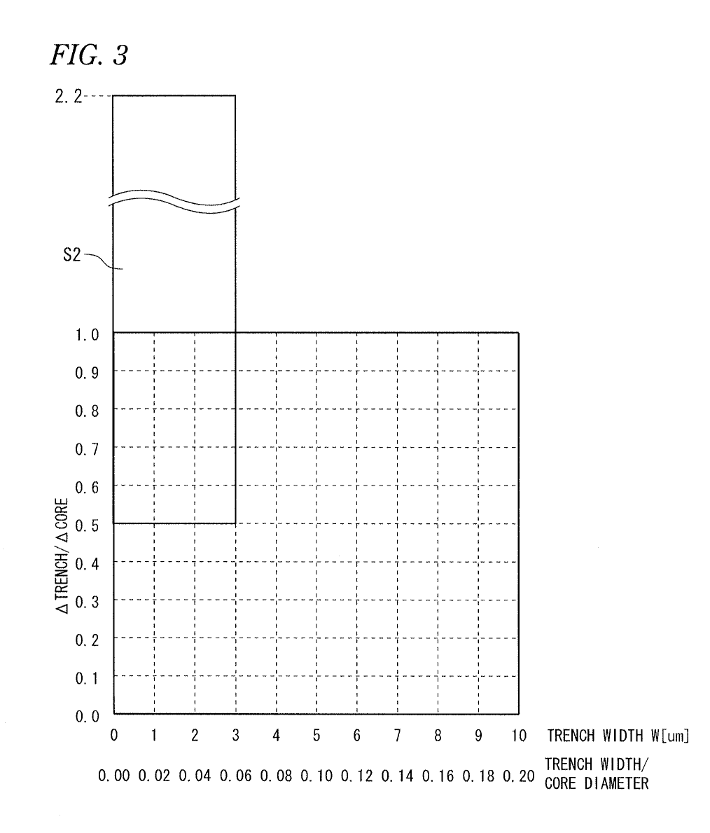

In a multi mode optical fiber 11 according to a second exemplary embodiment, a width dimension W of a trench layer 14 in a radial direction is set to 3 μm or smaller. Further, in the multi mode optical fiber 11, a ratio of an absolute value of Δ trench that is a refractive index difference between a cladding 13 and the trench layer 14 to an absolute value of Δ core that is a maximum refractive index difference between the cladding 13 and a core 12 is set to 0.5 or larger. Namely, the multi mode optical fiber 11 according to the second exemplary embodiment is, as shown in FIG. 3, set to a range shown by an area S2 in the relation between the ratio of the Δ trench to the Δ core and the width dimension W of the trench layer 14. For instance, an upper limit value of the ratio of the absolute value of the Δ trench to the absolute value of the Δ core is set to 2.2 or smaller. Further, the multi mode optical fiber 11 according to the second exemplary embodiment has a structure that a flat part (an inner cladding) 15 is not formed between the core 12 and the trench layer 14.

In the multi mode optical fiber 11 according to the second exemplary embodiment, since the ratio of the absolute value of the Δ trench to the absolute value of the Δ core is set to 0.5 or larger, a good bending property can be ensured. Thus, the multi mode optical fiber can withstand a practical use in which the multi mode optical fiber is sometimes bent to a bend radius of about 2 mm and can be wired without considering the bend radius like a general-purpose electric wire. Further, since the width dimension W of the trench layer 14 in the radial direction is set to 3 or smaller, a numerical aperture NA can be 0.24 or smaller, lights can be effectively guided to a light receiving range of a light receiving element such as a photodiode and a connection loss to the light receiving element can be suppressed to be low.

In the multi mode optical fiber 11 according to the second exemplary embodiment, the ratio of the absolute value of the Δ trench to the absolute value of the A core is preferably set to 0.6 or larger. In such a way, when the ratio of the absolute value of the Δ trench to the absolute value of the Δ core is set to 0.6 or larger, the bending property can be more improved, namely, an increase of transmission loss due to a bending can be more reduced.

### Third Exemplary Embodiment

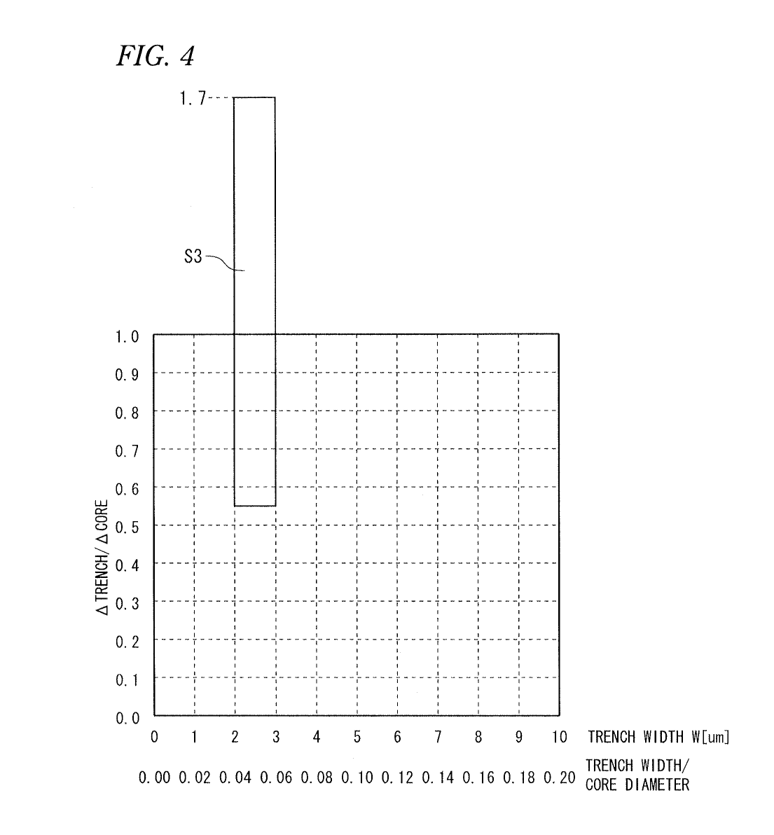

In a multi mode optical fiber 11 according to a third exemplary embodiment, a width dimension W of a trench layer 14 in a radial direction is set to 2 μm or larger and 3 μm or smaller. Further, in the multi mode optical fiber 11, a ratio of an absolute value of Δ trench that is a refractive index difference between a cladding 13 and the trench layer 14 to an absolute value of Δ core that is a maximum refractive index difference between the cladding 13 and a core 12 is set to 0.55 or larger. Namely, the multi mode optical fiber 11 according to the third exemplary embodiment is, as shown in FIG. 4, set to a range shown by an area S3 in the relation between the ratio of the absolute value of the Δ trench to the absolute value of the Δ core and the width dimension W of the trench layer 14. For instance, an upper limit value of the ratio of the absolute value of the Δ trench to the absolute value of the Δ core is set to 1.7 or smaller. Further, the multi mode optical fiber 11 according to the third exemplary embodiment has a structure that a flat part (an inner cladding) 15 is not formed between the core 12 and the trench layer 14.

In the multi mode optical fiber 11 according to the third exemplary embodiment, since the ratio of the absolute value of the Δ trench to the absolute value of the Δ core is set to 0.55 or larger, a good bending property can be ensured. Thus, the multi mode optical fiber can withstand a practical use in which the multi mode optical fiber is sometimes bent to a bend radius of about 2 mm and can be wired without considering the bend radius like a general-purpose electric wire. Further, since the width dimension W of the trench layer 14 in the radial direction is set to 2 μm or larger and 3 μm or smaller, a numerical aperture NA can be 0.24 or smaller, lights can be effectively guided to a light receiving range of a light receiving element such as a photodiode and a connection loss to the light receiving element can be suppressed to be low.

### Fourth Exemplary Embodiment

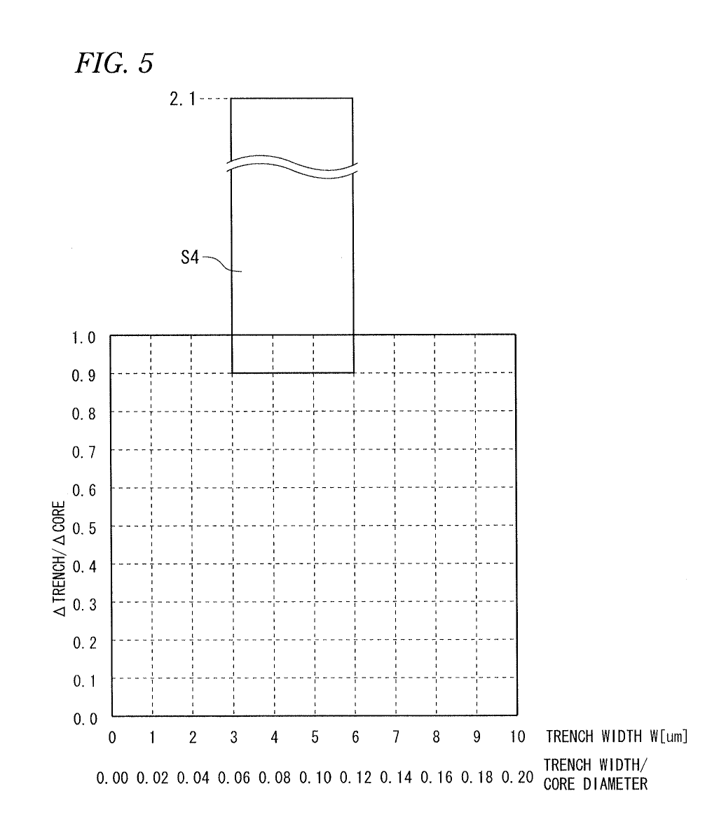

In a multi mode optical fiber 11 according to a fourth exemplary embodiment, a width dimension W of a trench layer 14 in a radial direction is set to 3 μm or larger and 6 μm or smaller. Further, in the multi mode optical fiber 11, a ratio of an absolute value of Δ trench that is a refractive index difference between a cladding 13 and the trench layer 14 to an absolute value of Δ core that is a maximum refractive index difference between the cladding 13 and a core 12 is set to 0.9 or larger. Namely, the multi mode optical fiber 11 according to the fourth exemplary embodiment is, as shown in FIG. 5, set to a range shown by an area S4 in the relation between the ratio of the absolute value of the Δ trench to the absolute value of the A core and the width dimension W of the trench layer 14. For instance, an upper limit value of the ratio of the absolute value of the Δ trench to the absolute value of the A core is set to 2.1 or smaller. Further, the multi mode optical fiber 11 according to the fourth exemplary embodiment has a structure that a flat part (an inner cladding) 15 is not formed between the core 12 and the trench layer 14.

In the multi mode optical fiber 11 according to the fourth exemplary embodiment, since the ratio of the absolute value of the Δ trench to the absolute value of the Δ core is set to 0.9 or larger, a good bending property can be ensured. Thus, the multi mode optical fiber can withstand a practical use in which the multi mode optical fiber is sometimes bent to a bend radius of about 2 mm and can be wired without considering the bend radius like a general-purpose electric wire. Further, since the width dimension W of the trench layer 14 in the radial direction is set to 3 μm or larger and 6 μm or smaller, a numerical aperture NA can be 0.24 or smaller, lights can be effectively guided to a light receiving range of a light receiving element such as a photodiode and a connection loss to the light receiving element can be suppressed to be low.

### Modified Example

Now, a modified example of the multi mode optical fiber according to the first exemplary embodiment will be described below. As shown in FIG. 6, a multi mode optical fiber 11A of the modified example is different from the first exemplary embodiment in view of a point that a flat part (an inner cladding) 15 is provided between a core 12 and a trench layer 14.

As shown in FIG. 6, the multi mode optical fiber 11A is provided with the flat part (the inner cladding) 15 between the core 12 and the trench layer 14. The flat part 15 has the same refractive index as that of a cladding 13. The flat part 15 is formed with, for instance, pure silica. The flat part 15 is provided so that a numerical aperture NA may be made small and a bending property may be more improved.

### Manufacturing Method of Multi Mode Optical Fiber

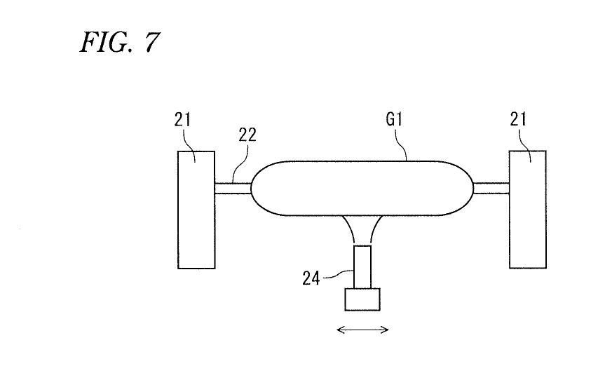

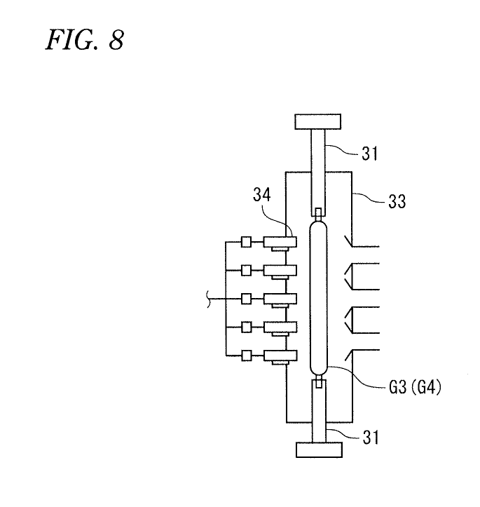

Now, an exemplary embodiment of a manufacturing method of the above-described multi mode optical fiber will be described below by referring to FIG. 7 and FIG. 8.

The multi mode optical fiber is manufactured by initially forming an optical fiber preform from which the multi mode optical fiber is produced, and then, drawing the optical fiber preform.

### (1) Optical Fiber Preform Manufacturing Process

(1-a1) Core Forming Process

For instance, a glass particles deposit G1 as a core glass body, which will become, the core 12 is manufactured by an OVD method (Outside Vapor Deposition Method). Firstly, a flame of a burner 24 which is installed in a side part and reciprocates in an axial direction is blown to a starting material 22 which is supported by a supporting device 21 and is turned on its axis. To the burner 24, glass source gas (SiCl₄), an additive (GeCl₄) for adjusting a refractive index, combustion gas (H₂) and combustion supporting gas (O₂) are supplied. Then, glass particles (SiO₂) synthesized by a hydrolytic reaction through an oxy-hydrogen flame from the burner 24 are blown to the starting material 22 while the burner 24 is reciprocated along the axial direction. Thus, the glass particles are deposited on the starting material 22 to manufacture the glass particles deposit G1.

At this time, the temperature of the flame of the burner 24 is adjusted, so that a concentration distribution of GeO₂ included in the glass particles deposit G1 is controlled to form the graded index type refractive index distribution. The glass particles deposit G1 may be manufactured not only by the OVD method, but also by a VAD method (Vapor Phase Axial Deposition Method). Further, the glass particles deposit G1 may be manufactured under a state that the starting material 22 is arranged by directing the axis of the starting material 22 to a vertical direction.

(1-a2) Transparent Finish and Elongating Process

After that, the glass particles deposit G1 is dehydrated, consolidated and allowed to be transparent to form a core glass body G2.

Then, the core glass body G2 is heated, softened and elongated in the axial direction by applying a tension to the core glass body to form a core glass rod G3.

(1-b1) Trench Layer Forming Process

A trench part which is the trench layer 14 is formed outside the core glass rod G3. Specifically, as shown in FIG. 8, in a furnace, flames of a plurality of burners 34 are blown to the core glass rod G3 which is supported by upper and lower supporting devices 31 and turns on its axis.

To these burners 34, the glass source gas (SiCl₄), the combustion gas (H₂) and the combustion supporting gas (O₂) are supplied. Then, the core glass rod G3 is reciprocated in the axial direction relatively to the burners 34 while glass particles synthesized by a hydrolytic reaction from the burners 34 are blown to the core glass rod G3. Thus, the glass particles are deposited on a periphery of the core glass rod G3 in the form of a layer.

(1-b2) Transparent Finish Process

Then, after the glass particles are deposited on the core glass rod G3, the core glass rod on which the glass particles are deposited is dehydrated, consolidated and allowed to be transparent to form a transparent glass body G4 in which the trench layer 14 is formed on the outer periphery of the core glass rod G3.

In the trench layer forming process, when the glass particles are deposited on the core glass rod, or when the core glass rod on which the glass particles are deposited is dehydrated and consolidated, fluorine is added to the trench layer 14. In order to add the fluorine when the glass particles are deposited on the core glass rod, an additive such as carbon tetra-fluoride (CF₄) is added to the glass source gas supplied to the burners 34.

(1-c1) Cladding Forming Process

A cladding part for the cladding 13 is formed outside the transparent glass body G4. Specifically, the glass particles of pure silica which substantially includes no additive for adjusting the refractive index are deposited on an outer periphery of the transparent glass body G4 by the OVD method. For instance, as shown in FIG. 8, in the furnace 33, the glass particles synthesized by a hydrolytic reaction from the plurality of burners 34 are blown to the transparent glass body G4 which is supported by the upper and lower supporting devices 31 and turns on its axis.

(1-c2) Transparent Finish Process

After that, the transparent glass body G4 on which the glass particles are deposited is dehydrated and consolidated so that the part of the deposited glass particles is finished to be transparent so as to form the optical fiber preform G. The cladding 13 may be formed not only by the OVD method, but also by the VAD method.

### (2) Drawing Process

A drawing process is carried out that a lower end of the manufactured optical fiber preform G is heated, molten and drawn downward. Thus, the multi mode optical fiber 11 or the multi mode optical fiber 11A is manufactured which includes the core 12 having the refractive index distribution of the curved form the central part of which protrudes, the cladding 13 provided in the periphery of the core 12 and having the constant refractive index lower than the refractive index of the core 12 and the trench layer 14 provided between the core 12 and the cladding 13 and having the constant refractive index lower than that of the cladding 13.

In the core glass body manufacturing process and the trench layer forming process in the manufacturing method of the above-described multi mode optical fiber, the temperature of the flame, a quantity of addition of the additive or a quantity of accumulation of the glass particles are adjusted. Thus, the width dimension W of the trench layer 14 of the obtained multi mode optical fibers 11 and 11A in the radial direction and the ratio of the absolute value of the Δ trench to the absolute value of the A core are adjusted. Accordingly, the multi mode optical fibers 11 according to the first to fourth exemplary embodiments and the multi mode optical fiber 11A of the modified example of the first exemplary embodiment can be easily obtained.

In the above-described manufacturing method of the multi mode optical fiber, the core forming process, the trench forming process and the cladding forming process of the optical fiber preform manufacturing process, after the glass particles are deposited, the part in which the glass particles are deposited is finished to be transparent. However, it is to be understood that the present invention is not limited to the above described example.

For instance, as a method for manufacturing the transparent glass body G4, a below-described example may be used. After the glass particles deposit G1 is manufactured in the core forming process, glass particles are deposited outside the glass particles deposit G1 in the form of a layer to form a trench part as the trench layer 14. Then, the glass particles deposit having a two-layer structure may be dehydrated, consolidated and finished to be transparent at the same time to manufacture the transparent glass body G4. The processes after the transparent glass body G4 may be the same as those of the above-described manufacturing method.

Further, in the method for manufacturing the transparent glass body G4, for instance, a below-described example may be used. A silica pipe to which fluorine is added is prepared as a trench part for the trench layer 14 to form a core part as the core 12 in an inner peripheral surface of the silica pipe by an inside deposition method (MCVD (Modified Chemical Vapor Deposition Method) or PCVD (Plasma-Activated Chemical Vapor Deposition Method). A process (a collapse process) that the silica pipe is heated to make the silica pipe solid may be carried out to manufacture the transparent glass body G4. The processes after the transparent glass body G4 may be the same as those of the above-described manufacturing method.

A process that the cladding 13 is formed outside the transparent glass body G4 is not limited to the process that the glass particles are deposited outside the transparent glass body G4 to allow the deposited glass particles to be transparent. For instance, a pure silica pipe may be prepared as a cladding part for the cladding 13 to carry out a process (a rod-in collapse process) that the transparent glass body G4 is inserted into a hollow part of the pure silica pipe to make the pipe solid so that the transparent glass body G4 is formed integrally with the pure silica pipe.

Further, for instance, as a method for manufacturing the optical fiber preform G, a below-described example may be used. Namely, a pure silica pipe is prepared as a cladding part for the cladding 13 to form a trench part for the trench layer in an inner peripheral surface of the pure silica pipe by the inside deposition method. Further, a core part for the core 12 is formed on an inner periphery of the trench part (nearer to an inner part of the pipe). A process (a collapse process) may be carried out that the pure silica pipe is heated to make the pure silica pipe solid so as to manufacture the optical fiber preform G. A thickness of the pure silica pipe in a radial direction which is initially prepared may be smaller than a thickness of the part for the cladding 13 in the radial direction of the preform. In this case, in another process, pure silica may be further attached to an outer peripheral side of the pure silica pipe.

Further, when the flat part 15 is formed as in the multi mode optical fiber 11A of the modified example 1, for instance, a layer made of pure silica for the flat layer 15 which has a prescribed thickness and has substantially no additive such as germanium or fluorine may be formed on an outer periphery of a part having the graded index type refractive index distribution in the glass particles deposit G1. The pure silica layer as the flat part 15 may be formed by the VAD method, the OVD method or the inside deposition method.

### EXAMPLES

As various kinds of multi mode optical fibers, multi mode optical fibers of examples 1 to 10 according to the present invention and multi mode optical fibers of comparative examples 1 to 5 are respectively manufactured. The numerical apertures NA and increases of bending loss of the manufactured multi mode optical fibers are respectively examined to evaluate the multi mode optical fibers. The numerical apertures NA are respectively examined when a distance to a light emitting element is 2 m and 100 m. Further, as for the bending loss, an increase of transmission loss is examined when the optical fiber is wound by two turns on a mandrel having a radius of 7.5 mm (two turns in the bend radius of 7.5 mm). Similarly, the increases of transmission losses are examined respectively when the optical fiber is wound by two turns in a bend radius of 5 mm, when the optical fiber is wound by a half turn in a bend radius of 3 mm and when the optical fiber is wound by a half turn in a bend radius of 1.75 mm.

### (1) Evaluation Samples

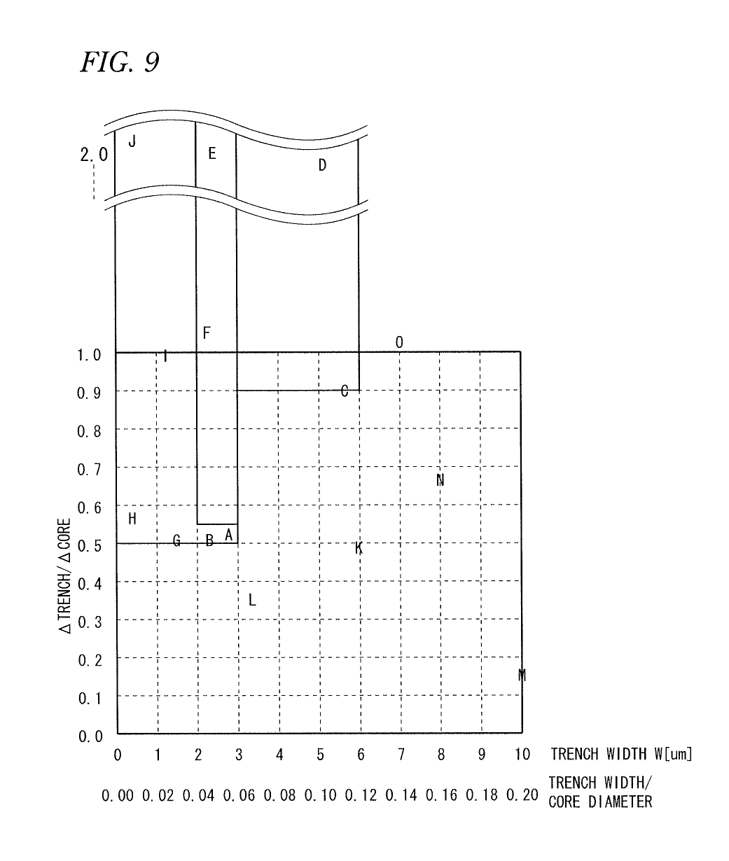

Δ cores, core diameters, Δ trenches, width dimensions of trench layers, ratios of absolute values of the Δ trenches to absolute values of the Δ cores, ratios of the core diameters (50 μm in the examples) to the trench widths of the examples 1 to 10 are shown in Table 1. Δ cores, core diameters, Δ trenches, width dimensions of trench layers, ratios of absolute values of the Δ trenches to absolute values of the Δ cores, and ratios of the core diameters (50 μm in the comparative examples) to the trench widths of the comparative examples 1 to 5 are shown in Table 2. Further, FIG. 9 shows relations between the ratios of the absolute values of the Δ trenches to the absolute values of the Δ cores and the width dimensions of the trench layers in the examples 1 to 10 and the comparative examples 1 to 5. As shown in FIG. 9, the examples 1 to 10 belong to any of the areas S1, S2, S3 and S4. The comparative examples 1 to 5 do not belong to the areas S1, S2, S3 and S4. In FIG. 9, the examples 1 to 10 are respectively designated by signs A to J, and the comparative examples 1 to 5 are respectively designated by K to O.

### (2) Evaluation Result

Evaluation results of the examples 1 to 10 are shown in the Table 1 and evaluation results of the comparative examples 1 to 5 are shown in the Table 2.

TABLE 1

| | | Example 1 | | Example 2 | | Example 3 | | Example 4 | | Example 5 | |
|---|---|---|---|---|---|---|---|---|---|---|---|
| Sign in FIG. 9 | | A | | B | | C | | D | | E | |
| Core | Δcore (specific | 1.06% | | 1.09% | | 1.0% | | 0.90% | | 1.0% | |
| Part | refractive index | | | | | | | | | | |
| | to cladding part | | | | | | | | | | |
| | (pure silica) | | | | | | | | | | |
| | Diameter | 50 | μm | 50 | μm | 50 | μm | 50 | μm | 50 | μm |
| Trench | Flat part | No | | No | | No | | No | | No | |
| layer | Δtrench (specific | −0.57% | | −0.56% | | −0.90% | | −1.9% | | −1.7% | |
| | refractive index | | | | | | | | | | |
| | to cladding part | | | | | | | | | | |
| | (pure silica) | | | | | | | | | | |
| | Width | 2.8 | μm | 2.1 | μm | 5.7 | μm | 5.6 | μm | 2.5 | μm |
| NA | 2 m | ◯ 0.22 | | ◯ 0.23 | | ◯ 0.24 | | ◯ 0.24 | | ◯ 0.24 | |
| | 100 m | ◯ 0.21 | | ◯ 0.22 | | ◯ 0.23 | | ◯ 0.24 | | ◯ 0.24 | |
| Bending | R7.5 mm. 2 turns | ◯ 0.07 | dB | ◯ 0.02 | dB | ◯ 0.00 | dB | ◯ 0.00 | dB | ◯ 0.00 | dB |
| loss | R5 mm, 2 turns | ◯ 0.20 | dB | ◯ 0.03 | dB | ◯ 0.01 | dB | ◯ 0.01 | dB | ◯ 0.01 | dB |
| | R3 mm, 0.5 turns | ◯ 0.25 | dB | ◯ 0.04 | dB | ◯ 0.02 | dB | ◯ 0.01 | dB | ◯ 0.01 | dB |
| | R1.75 mm, 0.5 turns | ◯ 0.9 | dB | ◯ 0.4 | dB | ◯ 0.2 | dB | ◯ 0.0 | dB | ◯ 0.1 | dB |
| | Ratio (Δtrench/Δcore) | 0.54 | | 0.51 | | 0.9 | | 2.1 | | 1.7 | |
| | Trench width/core | 0.056 | | 0.042 | | 0.114 | | 0.112 | | 0.050 | |
| | diameter (core | | | | | | | | | | |
| | diameter = 50 μm) | | | | | | | | | | |
| | | Example 6 | | Example 7 | | Example 8 | | Example 9 | | Example 10 | |
| Sign in FIG. 9 | | F | | G | | H | | I | | J | |
| Core | Δcore (specific | 0.93% | | 1.08% | | 1.08% | | 0.9% | | 0.9% | |
| Part | refractive index | | | | | | | | | | |
| | to cladding part | | | | | | | | | | |
| | (pure silica) | | | | | | | | | | |
| | Diameter | 50 | μm | 50 | μm | 50 | μm | 50 | μm | 50 | μm |
| Trench | Flat part | No | | Yes | | Yes | | Yes | | Yes | |
| layer | Δtrench (specific | −1.2% | | −0.55% | | −0.60% | | −0.9% | | −2.0% | |
| | refractive index | | | | | | | | | | |
| | to cladding part | | | | | | | | | | |
| | (pure silica) | | | | | | | | | | |
| | Width | 2.2 | μm | 1.5 | μm | 0.5 | μm | 1.2 | μm | 0.5 | μm |
| NA | 2 m | ◯ 0.22 | | ◯ 0.21 | | ◯ 0.22 | | ◯ 0.24 | | ◯ 0.24 | |
| | 100 m | ◯ 0.21 | | ◯ 0.21 | | ◯ 0.21 | | ◯ 0.22 | | ◯ 0.20 | |
| Bending | R7.5 mm. 2 turns | ◯ 0.02 | dB | ◯ 0.06 | dB | ◯ 0.12 | dB | ◯ 0.01 | dB | ◯ 0.00 | dB |
| loss | R5 mm, 2 turns | ◯ 0.03 | dB | ◯ 0.14 | dB | ◯ 0.25 | dB | ◯ 0.01 | dB | ◯ 0.01 | dB |
| | R3 mm, 0.5 turns | ◯ 0.05 | dB | ◯ 0.22 | dB | ◯ 0.33 | dB | ◯ 0.02 | dB | ◯ 0.02 | dB |
| | R1.75 mm, 0.5 turns | ◯ 0.1 | dB | ◯ 1.0 | dB | ◯ 1.0 | dB | ◯ 0.1 | dB | ◯ 0.1 | dB |

| | | | | | |
|---|---|---|---|---|---|
| Ratio (Δtrench/Δcore) | 1.29 | 0.51 | 0.56 | 1.0 | 2.2 |
| Trench width/core | 0.044 | 0.030 | 0.01 | 0.024 | 0.010 |
| diameter (core | | | | | |
| diameter = 50 μm) | | | | | |

As shown in the Table 1, in the multi mode optical fibers of the examples 1 to 10 according to the present invention, even when the bend radius is 1.75 mm, the pinch loss (the increase of the bending loss) can be suppressed to 1 dB or lower. Namely, it is understood that the multi mode optical fibers of the examples 1 to 10 can withstand the practical use in which the multi mode optical fibers are sometimes bent to the bend radius of about 2 mm, so that the multi mode optical fibers can be wired without considering the bend radius like the general-purpose electric wire. Further, in the multi mode optical fibers of the examples 1 to 10, the numerical aperture NA in the distance of 2 m and the numerical aperture NA in the distance of 100 m can be 0.24 or smaller. Namely, in the multi mode optical fibers of the examples 1 to 10, the lights can be effectively guided to the light receiving range of the light receiving element such as the photodiode and the connection loss to the light receiving element can be suppressed to be low.

TABLE 2

| | | Comparative | | Comparative | | Comparative | | Comparative | | Comparative | |
|---|---|---|---|---|---|---|---|---|---|---|---|
| | | Example 1 | | Example 2 | | Example 3 | | Example 4 | | Example 5 | |
| Sign in FIG. 9 | | K | | L | | M | | N | | O | |
| Core | Δcore (specific | 0.93% | | 1.08% | | 1.08% | | 0.9% | | 0.9% | |
| Part | refractive index | | | | | | | | | | |
| | to cladding part | | | | | | | | | | |
| | (pure silica) | | | | | | | | | | |
| | Diameter | 50 | μm | 50 | μm | 50 | μm | 50 | μm | 50 | μm |
| Trench | Flat part | yes | | yes | | no | | Yes | | Yes | |
| layer | Δtrench (specific | −0.46% | | −0.40% | | −0.18% | | −0.6% | | −1.0% | |
| | refractive index | | | | | | | | | | |
| | to cladding part | | | | | | | | | | |
| | (pure silica) | | | | | | | | | | |
| | Width | 6 | μm | 3.5 | μm | 10 | μm | 8 | μm | 7 | μm |
| NA | 2 m | ◯ 0.22 | | ◯ 0.21 | | ◯ 0.22 | | Δ 0.26 | | X 0.26 | |
| | 100 m | ◯ 0.21 | | ◯ 0.21 | | ◯ 0.21 | | X 0.25 | | X 0.25 | |
| Bending | R7.5 mm, 2 turns | ◯ 0.05 | dB | ◯ 0.06 | dB | ◯ 0.12 | dB | ◯ 0.01 | dB | ◯ 0.00 | dB |
| loss | R5 mm, 2 turns | ◯ 0.14 | dB | ◯ 0.14 | dB | ◯ 0.35 | dB | ◯ 0.01 | dB | ◯ 0.01 | dB |
| | R3 mm, 0.5 turns | ◯ 0.36 | dB | ◯ 0.22 | dB | ◯ 0.63 | dB | ◯ 0.02 | dB | ◯ 0.02 | dB |
| | R1.75 mm, 0.5 turns | X 1.7 | dB | X 1.4 | dB | X 2.5 | dB | ◯ 0.1 | dB | ◯ 0.1 | dB |

| | | | | | |
|---|---|---|---|---|---|
| Ratio (Δtrench/Δcore) | 0.49 | 0.37 | 0.17 | 0.67 | 1.11 |
| Trench width/core | 0.120 | 0.070 | 0.200 | 0.160 | 0.140 |
| diameter (core | | | | | |
| diameter = 50 μm) | | | | | |

As compared therewith, as shown in Table 2, in the multi mode optical fibers of the comparative examples 1 to 3, the numerical aperture NA can be 0.24 or smaller. However, when the bend radius is 1.75 mm, the pinch loss greatly exceeds 1 dB. Namely, it is understood that the multi mode optical fibers of the comparative examples 1 to 3 hardly withstand the practical use in which the multi mode optical fibers are sometimes bent to the bend radius of about 2 mm. Further, in the multi mode optical fibers of the comparative examples 4 and 5, even when the bend radius 1.75 mm, the pinch loss can be suppressed to 1 dB or smaller, however, the numerical aperture NA in the distance of 2 m and the numerical aperture NA in the distance of 100 m exceed 0.24. Namely, it is understood that the multi mode optical fibers of the comparative examples 5 and 6 can hardly guide the lights effectively to the light receiving range of the light receiving element such as the photodiode and the connection loss to the light receiving element arises.

As described above, it can be understood that, according to the multi mode optical fibers of the examples 1 to 10 included within the ranges of the areas S1, S2, S3 and S4, can be provided the multi mode optical fiber the numerical aperture of which can be made as small as possible and the bending property of which is excellent and the manufacturing method of the multi mode optical fiber.

Further, according to, for instance, the examples 4 to 6, and the examples 9 to 10, when the optical fiber is wound by two turns in the bend radius of 1.75 mm, the increase of transmission loss is 0.0 to 0.1 dB. Thus, it is recognized that the increase of transmission loss due to a bending is substantially suppressed. In the example 6 among them, the numerical aperture NA (2 mm) is 0.22 and the numerical aperture NA (100 m) is 0.21. Thus, it is understood that to obtain an excellent bending property and to make the numerical aperture as small as possible can be effectively made to be compatible with each other. Further, in the example 10, the numerical aperture NA (100 m) is 0.20. Thus, it is understood that to obtain an excellent bending property and to make the numerical aperture as small as possible can be effectively made to be compatible with each other.

### DESCRIPTION OF REFERENCE NUMERALS AND SIGNS

11: multi mode optical fiber
12: core
13: cladding
14: trench layer
15: flat part
22: starting material
G: optical fiber preform
G1: glass particles deposit
G2: core glass body
G3: core glass rod
G4: transparent glass body

1. A multi mode optical fiber comprising:
a core having a refractive index distribution of a curved form, a central part in a radial direction of which protrudes;
a cladding provided in the periphery of the core and having a constant refractive index lower than a maximum value of a refractive index of the core; and
a trench layer provided between the core and the cladding and having a constant refractive index lower than that of the cladding,
wherein a width dimension of the trench layer in the radial direction is set to 2 μm or smaller and a ratio of an absolute value of Δ trench that is a refractive index difference between the cladding and the trench layer to an absolute value of Δ core that is a maximum refractive index difference between the cladding and the core is set to 0.5 or larger,
wherein a transmission loss is 1 dB or lower, and
wherein a numerical aperture is 0.24 or smaller.

2. The multi mode optical fiber according to claim 1, wherein a flat part having the same refractive index as that of the cladding is provided between the core and the trench layer.

3. (canceled)

4. A multi mode optical fiber comprising:
a core having a refractive index distribution of a curved form, a central part in a radial direction of which protrudes;
a cladding provided in the periphery of the core and having a constant refractive index lower than a maximum value of a refractive index of the core; and
a trench layer provided so as to come into contact with an outer periphery of the core between the core and the cladding and having a constant refractive index lower than that of the cladding,
wherein a width dimension of the trench layer in the radial direction is set to 3 μm or smaller and a ratio of an absolute value of Δ trench that is a refractive index difference between the cladding and the trench layer to an absolute value of Δ core that is a maximum refractive index difference between the cladding and the core is set to 0.5 or larger,
wherein a transmission loss is 1 dB or lower, and
wherein a numerical aperture is 0.24 or smaller.

5. The multi mode optical fiber according to claim 4, wherein the ratio of the absolute value of the Δ trench to the absolute value of the Δ core is set to 0.6 or larger.

6. (canceled)

7. A multi mode optical fiber comprising:
a core having a refractive index distribution of a curved form, a central part in a radial direction of which protrudes;
a cladding provided in the periphery of the core and having a constant refractive index lower than a maximum value of a refractive index of the core; and
a trench layer provided so as to come into contact with an outer periphery of the core between the core and the cladding and having a constant refractive index lower than that of the cladding,
wherein a width dimension of the trench layer in the radial direction is set to 2 μm or larger and 3 μm or smaller and a ratio of an absolute value of Δ trench that is a refractive index difference between the cladding and the trench layer to an absolute value of Δ core that is a maximum refractive index difference between the cladding and the core is set to 0.55 or larger,
wherein a transmission loss is 1 dB or lower, and
wherein a numerical aperture is 0.24 or smaller.

8. (canceled)

9. A multi mode optical fiber comprising:
a core having a refractive index distribution of a curved form, a central part in a radial direction of which protrudes;
a cladding provided in the periphery of the core and having a constant refractive index lower than a maximum value of a refractive index of the core; and
a trench layer provided so as to come into contact with an outer periphery of the core between the core and the cladding and having a constant refractive index lower than that of the cladding,
wherein a width dimension of the trench layer in the radial direction is set to 3 μm or larger and 6 μm or smaller and a ratio of an absolute value of Δ trench that is a refractive index difference between the cladding and the trench layer to an absolute value of Δ core that is a maximum refractive index difference between the cladding and the core is set to 0.9 or larger,
wherein a transmission loss is 1 dB or lower, and
wherein a numerical aperture is 0.24 or smaller.

10. (canceled)
